(19) United States
(12) Patent Application Publication
(10) Pub. No.: US 2008/0293388 A1
(43) Pub. Date: Nov. 27, 2008

(54) METHOD AND APPARATUS FOR PROVIDING A PHONE BOOK FORWARDING LIST IN A COMMUNICATION SYSTEM

(75) Inventors: Steven Sobieszek, Addison, IL (US); Shawn W. Hogberg, Chandler, AZ (US); Daniel R. Tayloe, Phoenix, AZ (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/752,994

(22) Filed: May 24, 2007

(51) Int. Cl. H04M 3/42

(52) U.S. Cl. 455/414.1

(57) ABSTRACT

A method and corresponding entity for providing phone book forwarding list in a communication system (100) is described. The method comprises of receiving at a first mobile device (106) a notification message from a second mobile device (108). The notification message includes an identity of the second mobile device (108). The method includes registering the identity of the second mobile device (108) in a phone book forwarding list (222) of the first mobile device (106). The method further comprises sending the phone book forwarding list (222) when the first mobile device (106) receives a paging signal. The phone book forwarding list (222) is further utilized for forwarding the call to the second mobile device (108) when a communication session is not established with the first mobile device (106).

### FIELD OF THE INVENTION

The present invention generally relates to a communication system and more particularly relates to providing a phone book forwarding list in the communication system.

### BACKGROUND

In a wireless communication system, typically a call connection is established between a calling mobile device and a called mobile device. In general, the calling mobile device is a mobile device that initiates the call and the called mobile device is a mobile device that receives the call initiated by the calling mobile device. Typically, a network infrastructure in the wireless communication system acts as an interface between the calling mobile device and the called mobile device. The network infrastructure receives the call from the calling mobile device and accordingly routes the call to the called mobile device. There are times, however, when the called mobile device may be in silent or vibrating mode, or perhaps a user is temporarily separated from the called mobile device. In such an instance, the call made to the called mobile device may not be answered and the call connection may not be established.

Although the called mobile device is unreachable, a user of the calling mobile device believes that a user of the called mobile device may be with other individuals such as friends, co-workers, relatives, etc. who may have other mobile devices. However, the user of the calling mobile device may not know the identities, e.g. phone numbers, of the other mobile devices.

Thus, there is a need for a method by which the calling mobile device may establish a communication session with at least one mobile device that is known to the called mobile device when the call is not established between the calling and called mobile devices in close proximity to the called mobile device.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a system diagram of a communication system in accordance with some embodiments of the invention;

FIG. 2 is a block diagram of an entity in accordance with some embodiments of the invention;

FIG. 3 is a flowchart of a method for sending a phone book forwarding list in accordance with some embodiments of the invention;

FIG. 4 is a flowchart of a method for registering the identities of the mobile devices in the phone book forwarding list in accordance with some embodiments of the invention; and

FIG. 5 is a signal flow diagram for forwarding a call to a mobile device associated with an identity in the phone book forwarding list in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing any details, it should be observed that the embodiments reside primarily in an apparatus and method for providing a phone book forwarding list in a communication system. Accordingly, the apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of this description.

In this document, relational terms such as first and second, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that the embodiments described herein may be comprised of one or more conventional processors and unique stored program instructions that control the one or more processors to implement, in conjunction with certain non-processor circuits, some, most, or all of the functions required for optimizing paging in a communication network are described herein. The non-processor circuits may include, but are not limited to, a radio receiver, a radio transmitter, signal drivers, clock circuits, power source circuits, and user input devices. As such, these functions may be interpreted as steps of a method for providing a phone book forwarding list in a communication system. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Various embodiments are disclosed herein. For example, one method includes receiving at a first mobile device a notification message from a second mobile device, wherein the notification message includes an identity of the second mobile device. The method further includes registering the identity of the second mobile device in a phone book forwarding list of the first mobile device, and sending the phone book forwarding list when the first mobile device receives a paging signal.

Another embodiment includes an apparatus that comprises a memory for storing a phone book forwarding list. The phone book forwarding list comprises an identity of at least one mobile device to which a call made to the apparatus can be forwarded. The apparatus also includes a processor coupled to the memory operable to determine at least one mobile device to which the call is to be forwarded. The processor is further operable to register the identity of the determined mobile device in the phone book forwarding list and to send the phone book forwarding list when the apparatus receives a paging signal requesting the call be established with the apparatus.

In yet another embodiment, a method includes sending a signal to a called mobile device to establish a call between the called mobile device and a calling mobile device. The method then includes receiving a phone book forwarding list from the called mobile device. The method further includes sending a second signal to a first mobile device on the phone book forwarding list to establish the call with the first mobile device when the called mobile device does not establish the call with the calling mobile device.

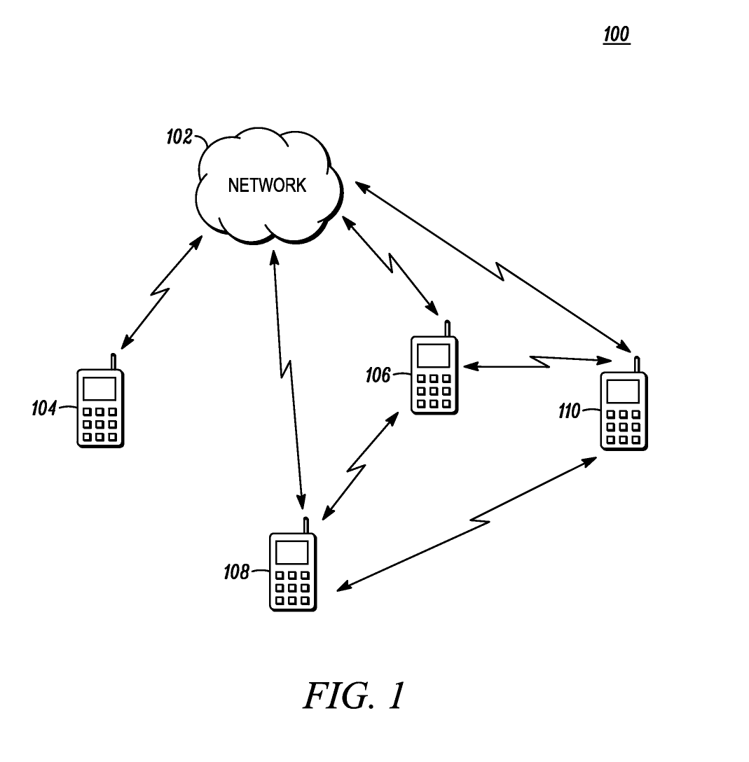

FIG. 1 illustrates a system diagram of a communication system 100 that the embodiments described utilize. The communication system 100 includes a network 102 and a plurality of mobile devices 104, 106, 108, 110. The mobile devices 104-110 are located at different positions in the communication system 100. The mobile devices 104-110 may communicate with each other using the network 102.

The communication system 100 provides for a phone book forwarding list for forwarding a call intended for a called mobile device to be made to another mobile device that is in close proximity to the called mobile device. In one example, the call is a request sent by the mobile device 104 to establish a communication session with the mobile device 106 via the network 102. During the process of establishing the communication session with the mobile device 106, the network 102 receives the phone book forwarding list from the mobile device 106. If the network 102 fails to establish the communication session with the mobile device 106, the network 102 utilizes the received phone book forwarding list to forward the call to another mobile device 108. The mobile device 108 is on the phone book forwarding list and is associated with the identity in the phone book forwarding list. In an embodiment, the mobile device 108 that receives the forwarded call will be located in close proximity to the mobile device 106 that sends the phone book forwarding list.

Each of the mobile devices 104-110 may be a called mobile device or a calling mobile device. The calling mobile device is the mobile device that initiates a call. Conversely, the called mobile device is the mobile device that receives the call initiated by the calling mobile device. For example, mobile device 104 is considered the calling mobile device when it initiates a call to set up a connection with the mobile device 106. In such an example, the mobile device 106 is considered the called mobile device.

In an embodiment, each of the mobile devices 104-110 in the communication system 100 may be a wireless device, a mobile station, user equipment, or any similar device that can transmit and receive signals. In an embodiment, each of the mobile devices 104-110 are configured to operate according to any of a number of different 2G, 3G and 4G wireless communication technologies. These include Global System for Mobile Communication (GSM), Code Division for Multiple Access (CDMA), Universal Mobile Telecommunication System (UMTS), Wideband Code Division for Multiple Access (W-CDMA), Orthogonal Frequency Division Multiplexing (OFDM), Worldwide Interoperability for Microwave Access (WiMax), Long-Term Evolution (LTE) and other communication technologies. The mobile devices 104-110 may also communicate with each other or with any other mobile devices using an IEEE 802.16-based wireless metropolitan area network or other technologies.

In an embodiment, the mobile devices 106-110 that are in close proximity to each other may directly communicate with each other utilizing any short range RF technology. Examples of short range RF technology include Bluetooth, Wi-Fi, Zigbee and similar protocols.

In an embodiment, the network 102 establishes communication with each of the mobile devices 104-1110. The network 102 transmits and receives signals from different mobile devices and infrastructure components (not shown) of the network 102 that provide wireless communication to each of the mobile devices 104-110. The network 102 may include a switching center that establishes a communication session between the called mobile device 106 and the calling mobile device 104. The network 102 initiates the communication session with the called mobile device 106 by sending a paging signal to the called mobile device 106. The paging signal is a message sent to alert the called mobile device 106 that the network 102 has received a call to be forwarded to the called mobile device 106.

An actual network may be significantly more complex and may include various additional known entities, such as base site controllers, billing, authorization, authentication, and voice mail servers that are not directly relevant to the present discussion. It is possible that neighboring networks may operate using the same or different communication technologies. The embodiments described focus on establishing communication between mobile devices 104-110.

Operationally, each of the mobile devices 104-110 is enabled for receiving the identity of a neighboring mobile device and registering the received identity in a phone book forwarding list of the mobile device. The neighboring mobile devices are those mobile devices that are in close proximity to the called mobile device. In one example, the ability to receive the identity and register the received identity is enabled in a called mobile device 106. Enabling may be performed by depressing a key, entering a voice command, selecting an option on a touch screen or by any other similar mechanism in the called mobile device 106. As used herein, identity is defined as any type of information that may be used to identify and/or communicate with a mobile device in the communication system 100. In an embodiment, the identity may be the mobile device's full identification number or just a subset of the digits, for example, the last four digits of the Mobile Information Device (MID) or International Mobile Subscriber Identity (IMSI).

The phone book forwarding list is a list of identities of at least one mobile device to which a call made to the called mobile device can be forwarded. For example, the phone book forwarding list can comprise the identities of neighboring mobile devices of the called mobile device 106. The phone book forwarding list is created for the called mobile device 106 by registering the identities of neighboring mobile devices, e.g. mobile devices 108, 110.

In an embodiment, the phone book forwarding list is sent to the network 102 when the called mobile device receives the paging signal from the network 102. The received phone book forwarding list is utilized by the network 102 when a communication session is not established with the called mobile device. For example, during the process of establishing the communication session with the called mobile device 106, the network 102 receives the phone book forwarding list from the called mobile device 106. If the communication session with the called mobile device 106 is not established, the network 102 utilizes the received phone book forwarding list to establish a communication session with another mobile device, e.g. mobile device 108.

Operationally, each of the mobile devices 104-110 subscribes to a phone book forwarding service provided by the network 102 before being able to send the phone book forwarding list to the network 102. For instance, a mobile device 106 subscribes to the phone book forwarding service provided by the network 102. The phone book forwarding service is a service activated by the network 102 for forwarding a call to a mobile device 108 associated with the identity in the phone book forwarding list. The mobile device 106 transmits the phone book forwarding list that is in response to the paging signal received from the network 102. In an embodiment, the phone book forwarding list may be sent along with a paging response or may be sent as a separate message to the network 102. The paging response is a response sent to the network 102 in reply to the received paging signal.

Operationally, the called mobile device 106 registers the identities of the neighboring mobile devices 108, 110 in the phone book forwarding list of the called mobile device 106. In one example, registering the identity of the mobile device 108 means to move the identity of the mobile device 108 from a preliminary phone book list of the called mobile device 106 to the phone book forwarding list of the called mobile device 106. The preliminary phone book list is a temporary list for storing the identity of the mobile device 108 before registering or moving the identity to the phone book forwarding list. The mobile devices 108, 110 periodically advertise their presence by broadcasting a notification message. The notification message is a broadcast message used for advertising availability of a mobile device, e.g. mobile device 108. The notification message includes an identity which uniquely identifies the mobile device 108 that transmits the notification message. In an embodiment, the notification message is transmitted with a low power using a technology such as Bluetooth, Wi-Fi, Zigbee or equivalent so that only those mobile devices that are in close proximity would be able to receive the notification message. In an alternate embodiment, the notification message is transmitted at regular time intervals so as to minimize a battery power drain.

The called mobile device 106 which is able to receive the notification message then attempts to register the identity of the mobile device 108 in the phone book forwarding list. In a similar way, each of the mobile devices 106-110 exchange their identity with each other and prepare the phone book forwarding list at each mobile device. The called mobile device 106 further sends the phone book forwarding list to the network 102 when the paging signal is received from the network 102. In an alternate embodiment, a user of the called mobile device 106 may manually configure the identities of the known mobile devices in the phone book forwarding list.

Operationally, the network 102 may establish the call with another mobile device when the calling mobile device is not able to establish the call with the called mobile device. For example, the calling mobile device 104 initiates a call to set up a communication session with the called mobile device 106 via the network 102. The network 102 in the process of establishing a communication session between the calling mobile device 104 and the called mobile device 106 receives a phone book forwarding list from the called mobile device 106. The network 102 utilizes the received phone book forwarding list to forward the call to a mobile device, e.g. mobile device 108, associated with the identity in the phone book forwarding list when the network 102 fails to establish the communication session with the called mobile device 106.

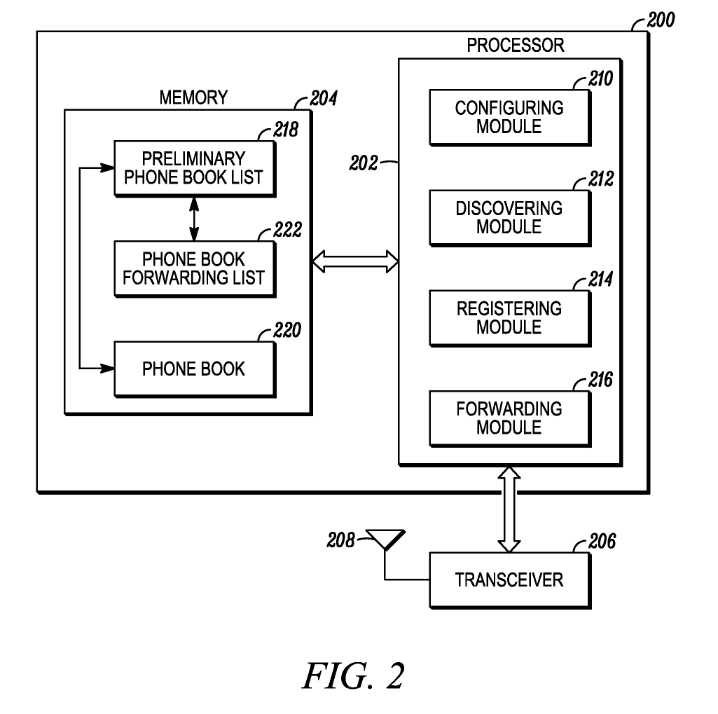

FIG. 2 is a block diagram of an apparatus in accordance with some embodiments of the invention. The apparatus herein referred as an entity 200 in FIG. 2. The entity 200 may be suitable for use as any one of the mobile devices 104-110 of the communication system 100 shown in FIG. 1. The entity 200 comprises at least a processor 202 and a memory 204.

The memory 204 is a common storage unit that stores a preliminary phone book list 218, a phone book 220, and the phone book forwarding list 222. The preliminary phone book list 218 is a storage unit used to store the identities of the mobile device that can potentially have a call forwarded to when the call is not established between the calling and the called mobile devices. In an embodiment, the preliminary phone list stores the identities of the neighboring mobile devices prior to registering the identities with the phone book forwarding list 222. The phone book 220 is a standard storage unit that includes all the identities stored by a user of the entity 200. For example, the user may store certain identities either by manually feeding numbers or by electronically transferring numbers from similar mobile devices. The phone book forwarding list comprises an identity of at least one mobile device to which a call made to the entity 200 can be forwarded.

The processor 202 coupled to the memory 204 operates to determine at least one mobile device to which the call is to be forwarded. The processor 202 comprises different modules for registering the identities of the neighboring mobile devices in the phone book forwarding list 222, and sending the phone book forwarding list 222 in response to the paging signal. The processor 202 comprises a configuring module 210, a discovering module 212, a registering module 214, and a forwarding module 216.

Operationally, the processor 202 utilizes configuring module 210 for enabling the entity 200 to receive the identities of the neighboring mobile devices and to register the received identity in a phone book forwarding list of the mobile device. The configuring module is also utilized for subscribing to the phone book forwarding service provided by the network before being able to send the phone book forwarding list to the network.

The processor 202 utilizes the discovering module 212 to determine at least one mobile device to which the entity 200 can forward the call. The discovering module 212 receives a notification message that comprises the identity of a mobile device, e.g. mobile device 108. The discovering module 212 further compares the received identity of the mobile device with the identities pre-stored in the phone book 220. If the received identity matches an identity in the phone book 220, the discovering module 212 stores the identity of the mobile device in the preliminary phone book list 218 of the memory 204. Otherwise, the discovering module 212 discards the received identity and monitors for a next notification message.

In an alternate embodiment, the discovering module 212 may use a web interface for manually configuring the preliminary phone book list 218. For example, the user may utilize discovering module to manually enter the identities or electronically transfer the identities of known mobile devices from any suitable mobile device to the preliminary phone book list 218 via the web interface.

Upon storing the received identity of the mobile device in the preliminary phone book list 218, the processor 202 utilizes registering module 214 to store the identity of the mobile device in the phone book forwarding list 222. The registering module 214 sends a phone book forwarding request message to the mobile device associated with the identity stored on the preliminary phone book list. The phone book forwarding request message is a message sent to the mobile device associated with the stored identity for obtaining permission to register the stored identity in the phone book forwarding list. The registering module 214 monitors for a response from the mobile device. In an embodiment, the response is an accept request message from the mobile device. In one example, the registering module monitors for the response for a predetermined period of time. If the received response from the mobile device associated with the stored identity is an acceptance of the phone book forwarding request message the registering module 214 registers the identity of the mobile device in the phone book forwarding list 222. For example, if the mobile device associated with the stored identity accepts the request, the registering module 214 receives an accept request message from the mobile device. On receiving the accept request message, the registering module 214 registers the identity of the mobile device in the phone book forwarding list. On the other hand, if the mobile device associated with the stored identity does not accept the request, the registering module 214 does not receive an accept request message from the mobile device. The registering module 214 then discards the stored identity from the preliminary phone book list 218. Thus, the processor 202 utilizes the discovering module 212 and the registering module 214 to process the received notification messages and register the identities of all neighboring mobile devices in the phone book forwarding list 222.

In an embodiment, the registering module 214 may use a web interface to interact with the mobile devices associated with the stored identities in the phone book forwarding list 222. For example, the registering module 214 may use the web interface to send the phone book forwarding request message or receive an accept request message in the form of emails, text messages, etc.

The processor 202 utilizes the forwarding module 216 to send the phone book forwarding list when the paging signal is received from a network, e.g. network 102. The entity 200 receives the paging signal from the network to set up the communication session with the calling mobile device. The entity 200 in return utilizes the forwarding module 216 to send its phone book forwarding list 222 along with the paging response to the network. In one example, the phone book forwarding list may be sent as a separate message to the network. On the other hand, the network, upon receiving the phone book forwarding list 222 from the entity 200, monitors for a call accept signal from the entity 200. When no response is received from the entity 200 of the called mobile device, the network utilizes the received phone book forwarding list 222 to forward the call to a mobile device, e.g. mobile device 108, identified in the phone book forwarding list 222.

In an embodiment of FIG. 2, the entity 200 is configured with a transceiver 206, which is coupled to the processor, and an antenna 208. The transceiver 206 is known and can vary with the communication technology. The transceiver 206 operates as a receiver and a transmitter for receiving and transmitting signals via the antenna 208 from or to the network. In an embodiment, the transceiver 206 operates for receiving and transmitting signals from different mobile devices and infrastructure components (not shown) of the network. In an embodiment, the transceiver 206 may be a separate transmitter and a receiver operating independently for transmitting and receiving signals in the communication system, e.g. system 100.

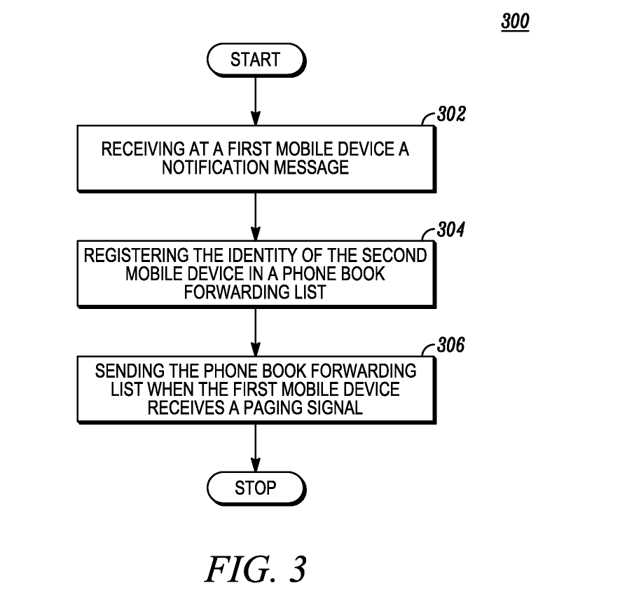

Referring to FIG. 3, a flowchart of a method 300 for sending a phone book forwarding list, e.g. phone book forwarding list 222, in accordance with some embodiments of the invention is shown. In an embodiment, the method 300 is described from the perspective of a called mobile device, e.g. mobile device 106. The phone book forwarding list of the called mobile device includes the list of identities of neighboring mobile devices to the called mobile device. As used herein, the called mobile device is referred as a first mobile device, e.g. mobile device 106, and a neighboring mobile device to the called mobile device is referred as a second mobile device, e.g. mobile device 108. The method 300 starts with receiving 302 at the first mobile device a notification message from the second mobile device. The received notification message includes the identity of the second mobile device. In one example, the received identity of the second mobile device is stored in a preliminary phone book list, e.g. preliminary phone book list 218, of the first mobile device.

In an alternate embodiment, the first mobile device may use a web interface to receive identity of the second mobile device in the form of emails, text messages etc. from the network or any type of mobile devices including the second mobile device.

The method 300 continues with the step of registering 304 the stored identity of the second mobile device, in the phone book forwarding list of the first mobile device. In an embodiment, registering 304 the identity of the second mobile device requires the first mobile device obtaining permission from the second mobile device. The first mobile device upon receiving the permission may then move the identity of the second mobile device from the preliminary phone book list of the first mobile device to the phone book forwarding list of the first mobile device. In one example, the permission may be an accept request message from the second mobile device. In another embodiment, the first mobile device may utilize a web interface to obtain the permission in the form of emails, text messages etc. from the network or any type of mobile devices including the second mobile device.

In an alternate embodiment, the first mobile device may receive the permission along with the notification message from the second mobile device. The first mobile device may then directly register the identity of the second mobile device in the phone book forwarding list.

The method 300, further to the step of registering 304 the identity of the second mobile device, proceeds to the step of sending the phone book forwarding list of the first mobile device to the network when the first mobile device receives the paging signal from the network in the communication system. In an embodiment, the phone book forwarding list is sent along with the paging response used to acknowledge the paging signal received from the network. In another embodiment, the phone book forwarding list may be sent before or after sending the paging response to the network.

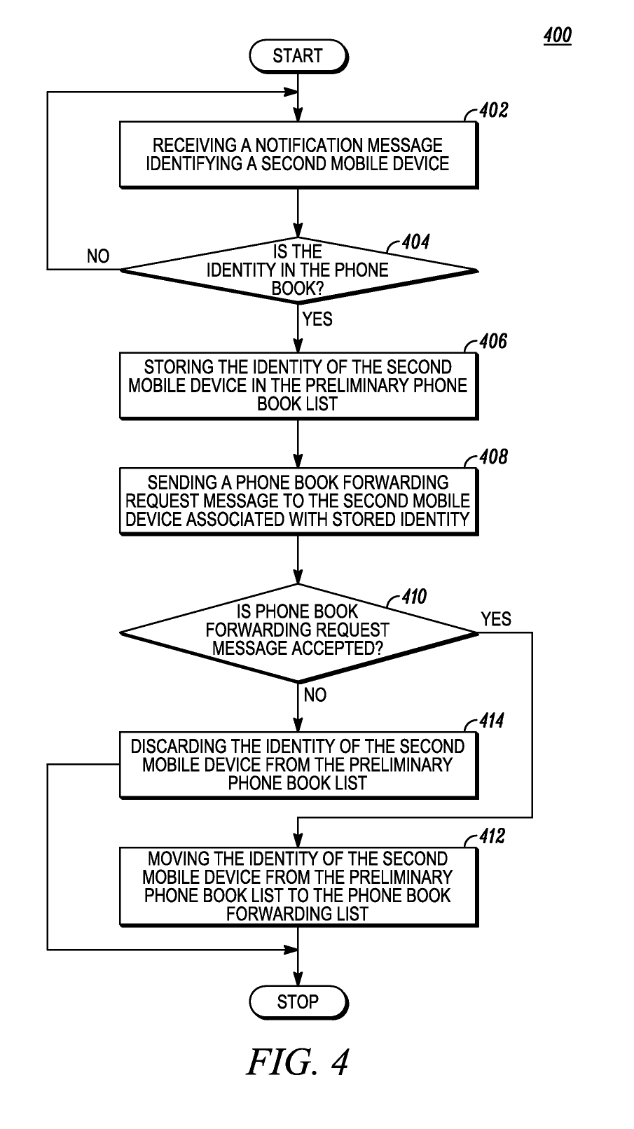

FIG. 4 is a flowchart of a method for registering the identities of the mobile devices in the phone book forwarding list of the mobile device in accordance with some embodiments of the invention. The method 400 is described with reference to FIG. 1. The method 400 is described from the perspective of a mobile device, e.g. mobile device 106, in close proximity with neighboring mobile devices, e.g. mobile devices 108, 110. For better understanding, the mobile device in close proximity to the neighboring mobile devices is referred to as a first mobile device, and one of the neighboring mobile devices of the first mobile device is referred to as a second mobile device.

The method 400 describes the steps 302 and 304 in accordance with some embodiments. The method 400 begins with the step of receiving 402 a notification message identifying the second mobile device as described in the step 302. The notification message is sent by the second mobile device and includes the identity of the second mobile device. Upon receiving the notification message, the method 400 determines 404 whether the received identity of the second mobile device is found in the phone book, e.g. phone book 220. One example of determining whether the received identity of the second mobile device is found in the phone book is by comparing the received identity with each of the pre-stored identities in the phone book. If the identity is matched with one of the identities in the phone book, the method 400 proceeds to the step of storing 406 the identity of the second mobile device in the preliminary phone book list, e.g. preliminary phone book list 218, of the first mobile device. Otherwise, the received identity of the second mobile device is discarded and the method 400 returns to the step of receiving 402 the notification message. After storing 406 the identity of the second mobile device, the method 400 proceeds to the step of sending 408 the phone book forwarding request message to the second mobile device associated with the stored identity. The first mobile device after sending 408 the phone book forwarding request message to the second mobile device monitors for a response from the second mobile device. In one example, monitoring occurs for a predetermined period of time.

The method 400 proceeds to the step of determining 410 whether the phone book forwarding request message is accepted. One example of determining whether the phone book forwarding request message is accepted, is by monitoring for an accept request message from the second mobile device. The accept request message indicates that the phone book forwarding request message is accepted by the second mobile device. If the phone book forwarding request message is accepted, the method 400 proceeds to the step of moving 412 the stored identity of the second mobile device from the preliminary phone book list to the phone book forwarding list, e.g. phone book forwarding list 222. Otherwise, the method 400 proceeds to the step of discarding 414 the identity of the second mobile device from the preliminary phone book list of the first mobile device. The method 400 is performed for all received notification messages. By processing all received notification messages, the phone book forwarding list of the first mobile device contains the identities of the neighboring mobile devices.

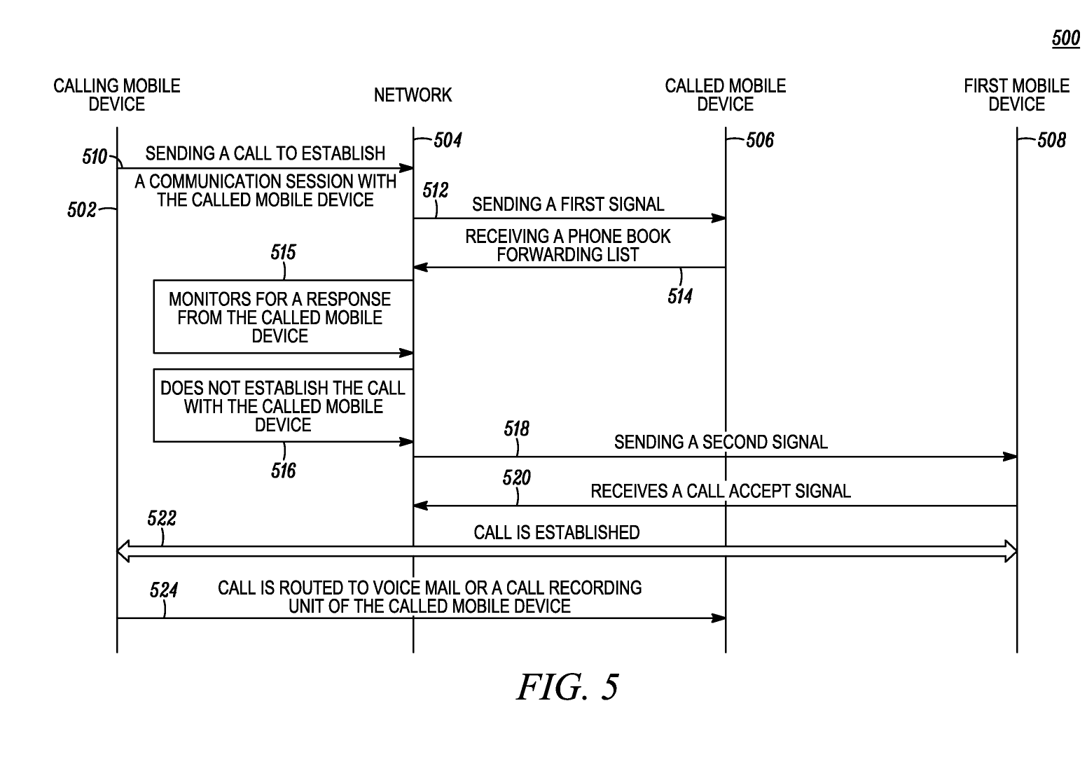

FIG. 5 is a signal flow diagram 500 for forwarding a call to a mobile device associated with an identity in a phone book forwarding list in accordance with some embodiments of the invention. The signal flow diagram 500 is described with reference to some elements found in FIG. 1. The signal flow diagram 500 illustrates the calling mobile device 104 sending 510 a call to the network 102 to establish a communication session with the called mobile device 106. The network 102 upon receiving the call sends 512 a first signal to the called mobile device 106 to establish a call between the called mobile device 106 and the calling mobile device 104. For example, the first signal may be a paging signal. The network 102 in return receives 514 the phone book forwarding list, which is created as shown in FIGS. 3 and 4, from the called mobile device 106. In one example, the called mobile device's phone book forwarding list is received in a paging response sent by the network 102. In another example, the phone book forwarding list may be sent along with a paging response or may be sent as a separate message to the network 102.

The network 102 further monitors 515 for a response from the called mobile device 106. For example, the network 102 may monitor for a call accept signal from the called mobile device 106 within a predetermined period of time. If the call accept signal is not received from the called mobile device 106, the network 102 does not 516 establish the call with the called mobile device 106. The signal flow diagram 500 proceeds to the next step where the network 102 utilizes the received phone book forwarding list from the called mobile device 106 to send 518 a second signal to the first mobile device 108 to establish the call with the first mobile device 108. For example, the second signal may be a paging signal. If the first mobile device 108 is ready to accept the call, the network 102 receives 520 a call accept signal from the first mobile device 108. In an embodiment, the network 102 may receive the phone book forwarding list of the first mobile device 108 along with a second paging response (not shown), before receiving the call accept signal from the first mobile device 108.

The signal flow diagram 500 proceeds to the next step, where the call is established 522 between the called mobile device 106 and the first mobile device 108. On the other hand, if the call is not accepted by the first mobile device 108, the call is routed 524 to voice mail or a call recording unit of the called mobile device 106.

In an alternate embodiment, if the calling mobile device 104 does not establish the call with the first mobile device 108, the network 102 selects a second mobile device in the phone book forwarding list of the called mobile device 106. The network 102 further forwards the call to the selected second mobile device (not shown). Thus, the above step of sending 518 a second signal to the step of establishing 522 the call is repeated to all the stored identities in the phone book forwarding list until the call is connected or the communication session is established with at least one neighboring mobile device of the called mobile device 106.

In an alternate embodiment, the user of the calling mobile device 104 may manually prioritize the stored identities in the phone book forwarding list received from the called mobile device 106. For example, the user may select the first mobile device 108 as a first priority mobile device and the second mobile device as a second priority mobile device. The network forwards the call based on the prioritized identities in the phone book forwarding list. For example, the call is first forwarded to the first mobile device 108. In case, if the network 102 does not establish the communication session with the first mobile device 108, the call is then forwarded to the second mobile device that has next lower priority.

In an alternate embodiment, the network 102 is configured with a calling party screen list. The calling party screen list is a list of identities of the calling mobile devices that are authorized to use the phone book forwarding list of the called mobile device 106. The calling party screen list is stored in the network 102 for screening calling mobile devices to use the phone book forwarding list. For example, the identity of the calling mobile device is compared with the identities in the calling party screen list prior to forwarding the call to the mobile device associated with the identity in the phone book forwarding list. The network 102 forwards the call only if the identity of the calling mobile device is matched with the identities in the calling party screen list.

In an embodiment, the network 102 may determine a location of the stored identities of neighboring mobile devices (referred to as mobile devices 108, 110 in FIG. 1) in the phone book forwarding list. The location is determined by using Global Positioning System (GPS), assisted GPS or by any other similar technologies. The determined location is stored in conjunction with the stored identity of the corresponding mobile device. When the called mobile device 106 is unable to establish the call with the calling mobile device 104, the network 102 utilizes the stored location information of the mobile devices in the phone book forwarding list. The network 102 selects the identity of the neighboring mobile device of the called mobile device 106. The network 102 further forwards the call to the selected mobile device. If the call is not established, the network 102 selects a next neighboring mobile device. Thus, the network 102 utilizes the location information in prioritizing the mobile devices associated with the identities in the phone book forwarding list.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method comprising:
receiving at a first mobile device a notification message from a second mobile device, wherein the notification message includes an identity of the second mobile device;
registering the identity of the second mobile device in a phone book forwarding list of the first mobile device; and
sending the phone book forwarding list when the first mobile device receives a paging signal.

2. The method of claim 1 further comprising enabling the first mobile device for receiving at the first mobile device the notification message from the second mobile device.

3. The method of claim 2 further comprising subscribing to a phone book forwarding service.

4. The method of claim 1 further comprising comparing the identity of the second mobile device with identities in a phone book in the first mobile device after receiving at the first mobile device the notification message from the second mobile device.

5. The method of claim 4 further comprising storing the identity of the second mobile device in a preliminary phone book list when the identity of the second mobile device is matched with at least one identity in the phone book.

6. The method of claim 1, further comprising:
sending a phone book forwarding request message to the second mobile device; and
receiving a response from the second mobile device before registering the identity of the second mobile device in the phone book forwarding list of the first mobile device.

7. The method of claim 6, wherein registering the identity of the second mobile device occurs when the received response is an acceptance of the phone book forwarding request message.

8. The method of claim 7, wherein registering the identity further comprising moving the identity of the second mobile device from a preliminary phone book list to the phone book forwarding list.

9. The method of claim 1 further comprising sending a paging response in reply to the received paging signal, wherein the paging response includes the phone book forwarding list.

10. The method of claim 1, wherein the phone book forwarding list is utilized for forwarding a call to the second mobile device when a communication session is not established with the first mobile device.

11. The method of claim 1, wherein the received notification message is a broadcast message for advertising availability of the second mobile device.

12. A method comprising:
sending a first signal to a called mobile device to establish a call between the called mobile device and a calling mobile device;
receiving a phone book forwarding list from the called mobile device; and
sending a second signal to a first mobile device in the phone book forwarding list to establish the call with the first mobile device when the calling mobile device does not establish the call with the called mobile device.

13. The method of claim 12, wherein the phone book forwarding list comprises an identity of at least one neighboring mobile device including the first mobile device located in close proximity to the called mobile device.

14. The method of claim 12 further comprising selecting a second mobile device in the phone book forwarding list when the calling mobile device does not establish the call with the first mobile device.

15. The method of claim 14 further comprising forwarding the call to the selected second mobile device in the phone book forwarding list.

16. The method of claim 12 further comprising monitoring for a response from the called mobile device within a predetermined period of time and wherein sending the second signal further comprising sending the second signal when the calling mobile device does not establish the call within the predetermined period of time.

17. An apparatus comprising:
a memory for storing a phone book forwarding list, wherein the phone book forwarding list comprises an identity of at least one mobile device to which a call made to the apparatus can be forwarded; and
a processor coupled to the memory operable to determine at least one mobile device to which the call be forwarded, to register the identity of the determined mobile device in the phone book forwarding list, and to send the phone book forwarding list when the apparatus receives a paging signal requesting the call be established with the apparatus.

18. The apparatus of claim 17, wherein the memory further comprises:
a preliminary phone book list; and
a phone book.

19. The apparatus of claim 17, wherein the processor coupled to the memory further comprises:
a discovering module operable to determine at least one mobile device to which the apparatus can forward the call;
a registering module operable to store an identity of the determined mobile device in the phone book forwarding list; and
a forwarding module operable to send the phone book forwarding list when the paging signal is received.

20. The apparatus of claim 19, wherein the discovering module is operable to receive a notification message comprising the identity of the mobile device, and is operable to store the identity of the mobile device in a preliminary phone book list when the identity of the mobile device matches an identity in the phone book.

21. The apparatus of claim 19, wherein the registering module is operable to send a phone book forwarding request message to the mobile device, and to receive an accept request message from the mobile device to register the identity of the mobile device in the phone book forwarding list.
